(19) United States
(12) Patent Application Publication
(10) Pub. No.: US 2023/0385596 A1
(43) Pub. Date: Nov. 30, 2023

(54) METHOD AND SYSTEM FOR EVALUATING CONSISTENCY OF AN ENGINEERED SYSTEM

(71) Applicant: Siemens Aktiengesellschaft, München (DE)

(72) Inventors: Serghei Mogoreanu, München (DE); Marcel Hildebrandt, München (DE)

(21) Appl. No.: 18/027,387

(22) PCT Filed: Sep. 7, 2021
(86) PCT No.: PCT/EP2021/074540

§ 371 Date: Mar. 21, 2023

(30) Foreign Application Priority Data
Sep. 28, 2020 (EP) 20198703.9

(51) Int. Cl. G06N 3/004; G06N 5/02

(52) U.S. Cl. CPC G06N 3/004; G06N 5/02

(57) ABSTRACT

A graph database stores a knowledge graph, with nodes of the knowledge graph corresponding to components of an engineered system and edges of the knowledge graph specifying connections between the components. A reasoning module is equipped with a first agent and a second agent. The agents have been trained with opposing goals and extract paths from the knowledge graph beginning with a node that corresponds to a first component of the engineered system. A prediction module uses a classifier to classify the extracted paths in order to produce a classification result, which indicates consistency, and in particular compatibility, of the first component in relation to the engineered system. This information is provided to an engineer, supporting him in validating the engineered system, for example an industrial automation solution. The method and system provide an automated data-driven algorithm that leverages a large collection of historical examples for consistency checking of components.

### CROSS-REFERENCE TO RELATED APPLICATIONS

This application claims priority to PCT Application No. PCT/EP2021/074540, having a filing date of Sep. 7, 2021, which claims priority to EP Application No. 20198703.9, having a filing date of Sep. 28, 2020, the entire contents both of which are hereby incorporated by reference.

### FIELD OF TECHNOLOGY

The following relates to a method and system for evaluating consistency of an engineered system.

### BACKGROUND

An engineered system, for example an industrial automation solution, is a complex system that consists of a multitude of individual components, the interplay of which fulfills functional requirements arising from an intended application. Due to the number of criteria that one needs to consider, configuring such a system is a very laborious task that requires a vast amount of domain-specific knowledge and is prone to mistakes. In addition, it is not uncommon to revise a previously configured automation solution due to one of the following reasons:
Change in functional or non-functional requirements towards the automation solution,
Change in a company's automation solution design practices,
Large number of issues that indicate a flaw in the original design,
Release of a better suited component.

### SUMMARY

An aspect relates to provide a method and system for evaluating consistency of an engineered system in order to facilitate configuration and/or reconfiguration of the engineered system.

According to the computer implemented method for evaluating consistency of an engineered system, wherein the engineered system is an industrial automation solution, the following operations are performed by one or more processors:
providing, by one or more of the processors accessing a graph database, a knowledge graph, with nodes of the knowledge graph corresponding to components of the engineered system and edges of the knowledge graph specifying connections between the components, and with the knowledge graph also containing nodes and edges describing other systems, wherein at least some components of the other systems are identical to components of the engineered system,
executing, by one or more of the processors, a first agent and a second agent, with the first agent and the second agent being reinforcement learning agents that have been trained with opposing goals to extract paths from the knowledge graph,
extracting a first path, by the first agent, and a second path, by the second agent, from the knowledge graph, with the first path and the second path beginning with a node that corresponds to a first component of the engineered system,
classifying, by one or more of the processors executing a classifier, the first path and the second path and producing a classification result, which indicates consistency, and in particular compatibility, of the first component in relation to the engineered system, and
outputting, by one or more of the processors accessing an output device, the classification result as well as the first path and/or the second path.

The system for evaluating consistency of an engineered system, wherein the engineered system is an industrial automation solution, comprises:
a graph database, storing a knowledge graph, with nodes of the knowledge graph corresponding to components of the engineered system and edges of the knowledge graph specifying connections between the components, and with the knowledge graph also containing nodes and edges describing other systems, wherein at least some components of the other systems are identical to components of the engineered system,
a reasoning module with a first agent and a second agent, configured for processing the knowledge graph, with the first agent and the second agent being reinforcement learning agents that have been trained with opposing goals to extract paths from the knowledge graph, and with the reasoning module being configured for extracting a first path, by the first agent, and a second path, by the second agent, from the knowledge graph, with the first path and the second path beginning with a node that corresponds to a first component of the engineered system,
a prediction module, containing a classifier that has been trained to classify the first path and the second path in order to produce a classification result, which indicates consistency, and in particular compatibility, of the first component in relation to the engineered system, and
one or more processors and an output device, configured for outputting the classification result as well as the first path and/or the second path.

According to some or all embodiments of the method and system, some or all of the other systems are also industrial automation solutions.

The method and system, or at least some of their embodiments, support an engineer in validating an existing engineered system, for example an industrial automation solution.

Any detected lack of consistency could be based on and highlight various inconsistencies, such as (i) incompatibility with the rest of the engineered system, (ii) abnormal choices of components, or (iii) components for which a better suited alternative exists.

The method and system, or at least some of their embodiments, could be used to not only increase the overall quality of the engineered system (while making the process of validating the choices made by their designers more efficient), but also to enable systematic knowledge transfer between more and less experienced engineers.

The method and system, or at least some of their embodiments, provide an automated data-driven algorithm that leverages a large collection of historical examples for consistency checking of components that constitute a complex engineered system, and that can naturally be represented in the form of a graph. In contrast to black-box machine learning techniques, explainable predictions are given that point the user to the part of the system where the issues arise.

The method and system, or at least some of their embodiments, are applicable to a wide variety of industrial configuration software, supporting engineers in detecting each of the different types of inconsistencies described earlier, so that they can ensure compatibility of the components within an industrial automation solution.

The method and system, or at least some of their embodiments, provide a data-driven and automated approach for validating complex engineered systems with the benefit of interpretable explanations for the given output. In comparison to rule-based systems, much less manual effort is required to formalize and subsequently maintain the experts' knowledge. In other words, the method and system, or at least some of their embodiments, can be easily scaled for use cases with a large selection of available components.

In contrast to typical machine learning methods, the proposed solution is capable of providing interpretable explanation for the predictions it is making, which is highly valuable for any application area, and can be essential for some. In critical applications, interpretable explanations are highly preferred over predictions made by a black box.

According to an embodiment of the method, the extracting and classifying of a first path and a second path are performed for each component of the engineered system. For each component, the outputting of the classification result as well as the respective first path and/or second path is performed only if the classification result indicates a level of consistency for the component that is below a threshold.

An embodiment of the method comprises the initial steps of selecting the other systems based on a computation of components that the other systems share with the engineered system, in particular by computing a Jaccard coefficient, and including nodes and edges describing the other systems in the knowledge graph.

An embodiment of the method comprises the initial steps of training the first agent with a reward that is positively correlated to the classification result, and, in particular simultaneously, training the second agent with a reward that is negatively correlated to the classification result. In particular, the first agent, the second agent and the classifier are trained simultaneously in an end-to-end training procedure.

In another embodiment of the method and system, the extraction of the first path, by the first agent, and the second path, by the second agent, is performed via sequential decision making.

In a further embodiment of the method and system, a decision problem of the first agent and the second agent is modelled as a Markov decision process.

In a further embodiment of the method and system, each action of the first agent and the second agent corresponds to a transition from one node in the knowledge graph to an adjacent node.

The computer-readable storage media have stored thereon instructions executable by one or more processors of a computer system, wherein execution of the instructions causes the computer system to perform the method.

The computer program product (non-transitory computer readable storage medium having instructions, which when executed by a processor, perform actions) is being executed by one or more processors of a computer system and performs the method.

### BRIEF DESCRIPTION

Some of the embodiments will be described in detail, with reference to the following figures, wherein like designations denote like members, wherein:

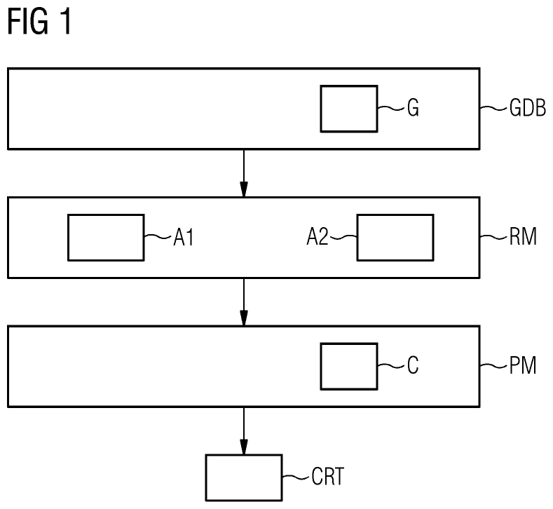

FIG. 1 shows a possible exemplary embodiment of a system for evaluating consistency of an engineered system;

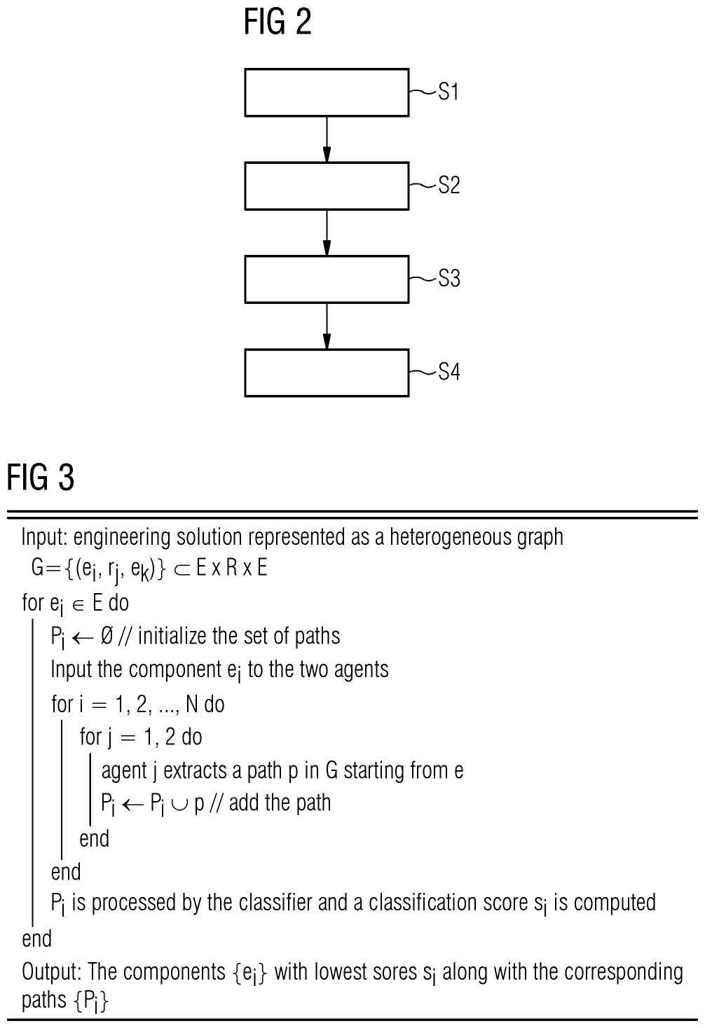

FIG. 2 shows a flowchart of a possible exemplary embodiment of a method for evaluating consistency of an engineered system; and

FIG. 3 shows a pseudocode of the workflow shown in FIG. 2.

### DETAILED DESCRIPTION

In the following description, various aspects of embodiments of the present invention will be described. However, it will be understood by those skilled in the art that embodiments may be practiced with only some or all aspects thereof. For purposes of explanation, specific numbers and configurations are set forth in order to provide a thorough understanding. However, it will also be apparent to those skilled in the art that the embodiments may be practiced without these specific details.

FIG. 1 shows an embodiment of a system for evaluating consistency of an engineered system.

This embodiment describes the technical features of a data-driven, automated system that evaluates the compatibility of components of an engineered system. The engineered system is consistent if all of its components are found to be compatible.

For our purposes, an engineered system is given by a heterogeneous system graph represented as a list of triples. That means Ĝ

Ĝ⊏E×R×E,

where E denotes the vertex set and R the set of edge types.

The vertices correspond to the configured components of the engineered system and the edge types specify how a pair of components is connected to each other. For example, a triple

(SiplusRack-4200, attached-left-slot, SIPLUS-CIM4210)∈Ĝ

contains the information that the Siplus-4200 rack and the central interface module SIPLUS-CIM4210 are configured. Moreover, the edge type specifies that the central interface module is attached to the left slot of the rack.

We define a knowledge graph G that contains not only the engineered system of interest, given by the system graph Ĝ defined above, but also a number of historical examples of other engineered systems (in the following: historical engineered systems), wherein at least some components of the historical engineered systems are identical to components of the engineered system. Those historical engineered systems should be selected based on some similarity criterion. One possibility is to select historical engineered systems that share common items with the system graph Ĝ (i.e., select engineered systems with the highest Jaccard coefficient).

In addition, the knowledge graph G contains triples of the form (component, feature name, feature value), that describe each of the components belonging to either of the included engineered systems on a technical level. As an example, a triple

(S7-1500PM1507,maximum current,25A)∈G

contains the information that the power supply component S7-1500 PM1507, belonging to one of the engineered systems contained in the knowledge graph G, is rated for a maximum of 25A of current.

FIG. 1 shows the knowledge graph G being stored in a graph database GDB.

A reasoning module RM processes the knowledge graph G and frames the task of consistency checking as a debate game between two reinforcement learning agents. Concretely, two competing reinforcement learning agents, a first agent A1 and a second agent A2, take a component eᵢ∈E from the system graph Ĝ as input and extract paths starting from eᵢ. These paths serve as features for a classification that predicts whether the component is compatible or incompatible. Thereby, the first agent A1 is supposed to extract paths that should serve as evidence that the component is compatible and the second agent A2 for the opposite position.

A classifier C is part of a prediction module PM and receives the paths that the first agent A1 and the second agent A2 have extracted from the knowledge graph G. The classifier C is trained in a supervised fashion to produce a score s(eᵢ) as a classification result CRT that indicates the compatibility of the component eᵢ. High classification scores correspond to compatible components.

The task of the first agent A1 and the second agent A2 is more complicated since extracting predictive paths in the knowledge graph G involves sequential decision making. For our purpose, the decision problem of the first agent A1 and the second agent A2 is modelled in terms of a Markov decision process (MDP). Starting from a component node eᵢ∈E, the objective of each agent is to extract a path in the knowledge graph G that serves as evidence for the agent's position. The agents' continuous state spaces are derived from a node embedding that encode the current location of the agent. Thus, the state space representation should guide the respective agent to sample transitions that allow to extend the path in the most promising way. An action corresponds to a transition from one node in the knowledge graph G to an adjacent one. After an action is sampled from a policy network of the respective agent the location of the respective agent and the state representation is updated accordingly.

The reward to each agent is computed based on the effect that an extracted path has on the decision of the classifier C. For example, if the first agent A1 extracts a path that leads to a high classification score s(eᵢ), the first agent A1 receives a high reward. The rationale is that the extracted path supports the position that eᵢ is compatible. Similarly, the rewards for the second agent A2 is inverse proportional to the classification score. During training the agents maximize their expected rewards using optimization methods such as REINFORCE.

The described embodiment can be integrated into an engineering configuration software assisting a user to pick appropriate components such that the whole system is functional.

FIG. 2 shows a workflow for evaluating consistency of an engineered system.

In a configuration step S1, a user configures an engineered system by selecting components and specifying their connections. This configuration process results in the system graph Ĝ.

In a graph building step S2, the knowledge graph G⊐Ĝ is built according to the procedure described with regard to FIG. 1.

In a reasoning step S3, the reasoning module RM shown in FIG. 1 takes the knowledge graph G as input and iterates over the configured components (i.e., the vertex set), i.e. for every component the first agent A1 and the second agent A2 take turns debating whether the component is compatible or not.

In a subsequent prediction step S4, the paths generated by the first agent A1 and the second agent A2 are input to the prediction module PM which classifies whether the component at hand is compatible or not. If a component is classified as incompatible it is shown to a user along with the extracted paths. In other words, the extracted paths (that act as an interpretable argument for the prediction) are output to the user. The user can then examine the extracted paths and decide to revise the engineered system (i.e., choose other components or connect them differently) and run the reasoning module RM again.

FIG. 3 shows a pseudocode of the workflow shown in FIG. 2.

Referring again to FIG. 1, it is now discussed how the classifier C as well as the first agent A1 and the second agent A2 can be trained. The training data set T consists of historical engineered systems that were configured in the past. That means, T={(G₁,X₁), (G₂, X₂), . . . , (G_{T}, X_{T})} where each graph GL corresponds to a graph representation of a previous engineering project and each list Xᵢ is a list of components that are incompatible with the remainder of the components.

There are different ways to create the training data set T. In particular, the negative sample points provided by the lists Xᵢ require additional care. Among other possibilities, one could manually select the entries of each list Xᵢ (i.e., a domain expert is selecting engineering components which are known to be incompatible), randomly sample each list Xᵢ (based on the assumption that randomly configuring a component at a random position will most likely lead to inconsistencies; however, this might lead to so-called false-negatives), or define a set of (possibly non-exhaustive) rules that specify when components are consistent and generate each list Xᵢ accordingly.

Our goal is to classify the components in each list Xᵢ as incompatible and the remainder of the components as compatible. The supervision signal given by each list Xᵢ is used to train the classifier C. The decisions of the classifier C in turn produce reward signals for the first agent A1 and the second agent A2. The whole architecture can be trained end-to-end.

When the training process is completed the performance is evaluated on a validation set that is similar to the training data set T but contains instances of engineered systems and incompatible components that were not encountered during training.

The method can be executed by a processor such as a microcontroller or a microprocessor, by an Application Specific Integrated Circuit (ASIC), by any kind of computer, including mobile computing devices such as tablet computers, smartphones or laptops, or by one or more servers in a control room or cloud. For example, a processor, controller, or integrated circuit of the computer system and/or another processor may be configured to implement the acts described herein.

The above-described method may be implemented via a computer program product including one or more computer-readable storage media having stored thereon instructions executable by one or more processors of a computing system. Execution of the instructions causes the computing system to perform operations corresponding with the acts of the method described above.

The instructions for implementing processes or methods described herein may be provided on non-transitory computer-readable storage media or memories, such as a cache, buffer, RAM, FLASH, removable media, hard drive, or other computer readable storage media. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer implemented method for evaluating consistency of an engineered system, wherein the engineered system is an industrial automation solution, comprising:
providing, by one or more of processors accessing a graph database, a knowledge graph, with nodes of the knowledge graph corresponding to components of the engineered system and edges of the knowledge graph specifying connections between the components, and with the knowledge graph also containing nodes and edges describing other systems, wherein at least some components of the other systems are identical to components of the engineered system;
executing, by the one or more of the processors, a first agent and a second agent, with the first agent and the second agent being reinforcement learning agents that have been trained with opposing goals to extract paths from the knowledge graph;
extracting a first path, by the first agent, and a second path, by the second agent, from the knowledge graph, with the first path and the second path beginning with a node that corresponds to a first component of the engineered system;
classifying, by the one or more of the processors executing a classifier, the first path and the second path and producing a classification result, which indicates consistency, and compatibility, of the first component in relation to the engineered system; and
outputting, by the one or more of the processors accessing an output device, the classification result as well as the first path and/or the second path.

2. The method of claim 1, wherein:
the extracting and classifying of the first path and the second path are performed for each component of the engineered system, and
for each component, the outputting of the classification result as well as the respective first path and/or second path is performed only if the classification result indicates a level of consistency for the component that is below a threshold.

3. The method according to claim 1, comprising:
selecting the other systems based on a computation of components that the other systems share with the engineered system, by computing a Jaccard coefficient, and
including nodes and edges describing the other systems in the knowledge graph.

4. The method according to claim 1, comprising:
training the first agent with a reward that is positively correlated to the classification result, and, simultaneously,
training the second agent with a reward that is negatively correlated to the classification result.

5. The method according to claim 4,
wherein the first agent, the second agent, and the classifier are trained simultaneously in an end-to-end training procedure.

6. The method according to claim 1,
wherein extracting the first path, by the first agent, and the second path, by the second agent, is performed via sequential decision making.

7. The method according to claim 6,
wherein a decision problem of the first agent and the second agent is modelled as a Markov decision process.

8. The method according to claim 6,
wherein each action of the first agent and the second agent corresponds to a transition from one node in the knowledge graph to an adjacent node.

9. A system for evaluating consistency of an engineered system, wherein the engineered system is an industrial automation solution, the system comprising:
a graph database, storing a knowledge graph, with nodes of the knowledge graph corresponding to components of the engineered system and edges of the knowledge graph specifying connections between the components, and with the knowledge graph also containing nodes and edges describing other systems, wherein at least some components of the other systems are identical to components of the engineered system;
a reasoning module with a first agent and a second agent, configured for processing the knowledge graph, with the first agent and the second agent being reinforcement learning agents that have been trained with opposing goals to extract paths from the knowledge graph, and with the reasoning module being configured for extracting a first path, by the first agent, and a second path, by the second agent from the knowledge graph, with the first path and the second path beginning with a node that corresponds to a first component of the engineered system;
a prediction module, containing a classifier that has been trained to classify the first path and the second path produce a classification result, which indicates consistency, and compatibility, of the first component in relation to the engineered system; and
one or more processors and an output device, configured for outputting the classification result as well as the first path and/or the second path.

10. A computer-readable storage media having stored thereon:
instructions executable by one or more processors of a computer system, wherein execution of the instructions causes the computer system to perform the method according to claim 1.

11. A computer program product, comprising a computer readable hardware storage device having computer readable program code stored therein, said program code executable by a processor of a computer system to implement a method, according to claim 1.
